(19) United States
(12) Patent Application Publication
(10) Pub. No.: US 2015/0053778 A1
(43) Pub. Date: Feb. 26, 2015

(54) THERMOSTAT DEVICE AND COOLING SYSTEM

(71) Applicant: Scania CV AB, Södertälje (SE)

(72) Inventor: Fredrik Uhman, Huddinge (SE)

(73) Assignee: Scania CV AB, Sodertalje (SE)

(21) Appl. No.: 14/390,467

(22) PCT Filed: Mar. 25, 2013
(86) PCT No.: PCT/SE2013/050326

§ 371 Date: Oct. 3, 2014

(30) Foreign Application Priority Data
Apr. 5, 2012 (SE) 1250351-2

(51) Int. Cl. F01P 7/16; G05D 23/185

(52) U.S. Cl. CPC F01P 7/16; G05D 23/1852
USPC 236/34.5; 236/101 C

(57) ABSTRACT

A thermostat device (1) for a cooling system in a motor vehicle, includes an inlet duct (3) to receive cooling fluid that is circulated through the combustion engine of the motor vehicle, an inlet opening (17) to receive cooling fluid from a pilot line in the cooling system, a first and second outlet duct (5a, 5b); an axially displaceable valve rod (11), on which a valve body (10) is secured; a temperature-dependent activating element (14) of a wax which is arranged to influence the displacement position of the valve rod in dependence upon the temperature of the cooling fluid that is received via the inlet opening (17); and the inlet opening is connected with the second outlet duct (5b) via a connecting duct (18) that extends in an axial direction through the valve rod. Also a cooling system including such a thermostat device.

### TECHNICAL FIELD OF THE INVENTION AND PRIOR ART

The present invention concerns a thermostat device according to the preamble to claim 1 and a cooling system according to the preamble to claim 7.

A thermostat device comprising a temperature-dependent activating element with a wax body is often used to regulate the temperature of the cooling fluid in the cooling system that cools the combustion engine in a motor vehicle. The thermostat device conducts, in dependence upon the temperature of the cooling fluid, the cooling fluid flowing out from the combustion engine either to a radiator to be cooled before the cooling fluid is returned to the combustion engine or directly back to the combustion engine without passing through the radiator. In many motor vehicles the thermostat device is coupled into the cooling circuit of the cooling system between the cooling fluid outlet of the combustion engine and the cooling fluid inlet of the radiator. It has been shown to be advantageous to control the thermostat device in dependence upon the temperature of the cooling fluid that is conducted into the combustion engine instead of controlling the thermostat device in dependence upon the temperature of the cooling fluid that leaves the combustion engine. To enable such control without having to change the placement of the thermostat device in the cooling circuit, thermostat devices have been developed that are arranged so as to receive a controlling cooling fluid flow from a pilot line that diverts a part of the cooling fluid that is flowing toward the cooling fluid inlet of the combustion engine. Thermostat devices of the latter type are previously known from EP 2 037 097 A2 and EP 2 366 878 A2.

### OBJECT OF THE INVENTION

The object of the present invention is to provide a thermostat device of the type specified above with a new and advantageous design.

### SUMMARY OF THE INVENTION

Said object is achieved according to the present invention by means of a thermostat device exhibiting the features defined in claim 1.

The thermostat device according to the invention comprises:
an inlet duct intended for receiving cooling fluid that is circulated through a combustion engine in a motor vehicle,
an inlet opening intended for receiving cooling fluid from a pilot line,
a first outlet duct, which is connected to said inlet duct and from which cooling fluid is intended to be conducted to a radiator,
a second outlet duct, which is connected to said inlet duct and from which cooling fluid is intended to be returned to the combustion engine without passing through said radiator,
a valve body, which is displaceable between various positions for regulating the flow of cooling fluid from said inlet duct to said outlet ducts,
a temperature-dependent activating element, and
an axially displaceable valve rod, on which the valve body is secured, wherein the activating element is arranged so as to influence the displacement position of the valve rod and the valve body in dependence upon the temperature of the cooling fluid that is received via said inlet opening, and wherein said inlet opening is connected to the second outlet duct via a connecting duct that extends in an axial direction through the valve rod.

The valve rod is thus used in the thermostat device according to the invention to conduct the cooling fluid that is received from the pilot line to the second outlet duct. As a result, the thermostat device can be given a particularly compact and space-efficient design.

According to the invention, the valve rod extents through a wax body incorporated in the activating element in order to enable the transfer of heat to the wax body from cooling fluid that flows through said connecting duct inside the valve rod. Heating the wax body from within in this manner enables more efficient through-heating of the wax body under the action of the heat from the cooling fluid that flows through the connecting duct inside the valve rod compared to a thermostat device of the conventional type in which the wax body is heated from without.

A embodiment of the invention is characterized in that:
the thermostat device comprises a piston chamber and a displaceable piston that is received in the piston chamber, whereupon the valve rod extends through said piston chamber,
said piston is fixedly connected to and disposed on the outside of the valve rod, and
the wax body is housed in the piston chamber and arranged so as to act upon said piston.

It thereby becomes possible to convert the expansion of the wax body into an axial displacement of the valve rod and the valve body in an effective and space-efficient manner.

Other advantageous features of the thermostat device according to the invention are described in the non-independent claims and the description that follows below.

The invention also concerns a cooling system exhibiting the features defined in claim 7.

### BRIEF DESCRIPTION OF THE DRAWINGS

The invention will be described below with the help of exemplary embodiments, and with reference to the attached drawings. The following are depicted:

FIG. 1 a side view of a thermostat device according to a first embodiment of the present invention,

FIG. 2 a front view of the thermostat device according to FIG. 1,

FIG. 3 a section along the line III-III in FIG. 2,

FIG. 4 a section through a thermostat device according to a second embodiment of the invention, and

FIG. 5 a schematic diagram of a cooling system comprising a thermostat device according to the invention.

### DETAILED DESCRIPTION OF EMBODIMENTS OF THE INVENTION

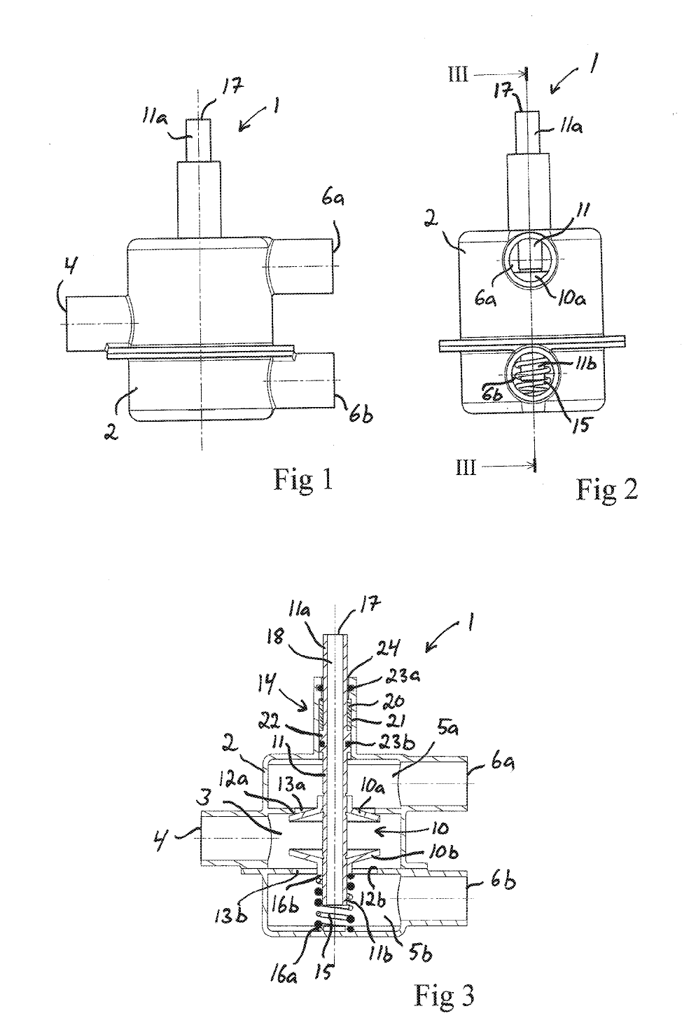

FIGS. 1-3 illustrate a thermostat device 1 according to an embodiment of the present invention. This thermostat device 1 is intended to be incorporated in a cooling system in a motor vehicle, for example a cooling system 40 of the type illustrated in FIG. 5. The thermostat device 1 comprises a thermostat housing 2. An inlet duct 3 for receiving cooling fluid that is circulated through a combustion engine in the motor vehicle is arranged in the thermostat housing 2. This inlet duct 3 is intended to be connected to a line in said cooling system so to be able, via an inlet opening 4 arranged in the thermostat housing 2, to receive cooling fluid from said line. A first outlet duct 5a and a second outlet duct 5b are further arranged in the thermostat housing 2. Both of these outlet ducts 5a, 5b are connected to the inlet duct 3. Cooling fluid from the first outlet duct 5a is intended to be conducted from the thermostat device 1 to a radiator in said cooling system, while cooling fluid from the second outlet duct 5b is intended to be returned to the combustion engine without passing through said radiator. The first outlet duct 5a is intended to be connected to a line in said cooling system in order to make it possible, via a first outlet opening 6a arranged in the thermostat housing 2, to pass cooling fluid to said line, while the second outlet duct 5b is intended to be connected to a second line in said cooling system in order to make it possible, via a second outlet opening 6b arranged in the thermostat housing 2, to pass cooling fluid to said latter line.

A valve body 10 is displaceably arranged in the thermostat housing 2. This valve body 10 is axially displaceable between various positions for regulating the flow of cooling fluid from said inlet duct 3 to said outlet ducts 5a, 5b. The valve body 10 is secured on and displaceable together with an axially displaceable valve rod 11, which is displaceably disposed in the thermostat housing 2. A first valve seat 12a is arranged in the thermostat housing 2 between the inlet duct 3 and the first outlet duct 5a, and a second valve seat 12b is arranged in the thermostat housing 2 between the inlet duct 3 and the second outlet duct 5b. In the illustrated example, the first valve seat 12 is formed by an edge that extends around a first opening 13a that constitutes a flow passage between the inlet duct 3 and the first outlet duct 5a, while the second valve seat 12b is formed by an edge that extends around a second opening 13b that constitutes a flow passage between the inlet duct 3 and the second outlet duct 5b. The valve body 10 comprises a first valve member 10a which, in a first end position of the valve body, is receivable in the first valve seat 12a in order to close said first opening 13a and thereby prevent cooling fluid from flowing from the inlet duct 3 to the first outlet duct 5a. The valve body 10 further comprises a second valve member 10b which, in a second end position of the valve body, is receivable in the second valve seat 12b in order to close said second opening 13b and thereby prevent cooling fluid from flowing from the inlet duct 3 to the second outlet duct 5b. The two valve members 10a, 10b are arranged at a distance from one another viewed in the axial direction of the valve rod. When the first valve member 10a is located in its closed position in engagement with the first valve seat 12a, the second valve member 10b is located in an open position at a distance from the second valve seat 12b, as is illustrated in FIG. 3, whereupon cooling fluid is thereby allowed to flow from the inlet duct 3 to the second outlet duct 5b via said second opening 13b. When the second valve member 10b is located in its closed position in engagement with the second valve seat 12b, the first valve member 10a is located in an open position at a distance from the first valve seat 12a, whereupon cooling fluid is thereby allowed to flow from the inlet duct 3 to the first outlet duct 5a via said first opening 13a. When the valve body 10 is located in a position between said end positions, cooling fluid is allowed to flow from the inlet duct 3 in varying degree to both the first outlet duct 5a via said first opening 13a and the second outlet duct 5b via said second opening 13b. The valve rod 11 extends through the centers of respective valve members 10a, 10b. In the illustrated example, respective valve members 10a, 10b consist of conical valve heads.

The valve body 10 is displaceable from said first end position in the direction of said second end position under the action of an activating element 14 arranged in the thermostat housing 2, and against the action of the spring force from a spring device 15 acting on the valve body 10 or the valve rod 11. In the illustrated example the spring device 15 consists of a compression spring, one end of which bears against a support surface 16a inside the second outlet duct 5b and the other end of which bears against a support surface on the second valve member 10b. This compression spring surrounds an end 11b of the valve rod, which end is received in the second outlet duct 5b.

The thermostat device 1 further comprises an inlet opening 17 that is intended to receive cooling fluid from a pilot line in said cooling system. The activating element 14 is arranged so as to influence the displacement position of the valve rod 11 and the valve body 10 in dependence upon the temperature of the cooling fluid that is received from the pilot line via said inlet opening 17. The inlet opening 17 is connected to the second outlet duct 5b via a connecting duct 18 that extends in an axial direction through the valve rod 11. The cooling fluid received from the pilot line is always allowed to flow further to the second outlet duct 5b via the connecting duct 18 regardless of the position of the valve rod 11 and the valve body 10.

In the illustrated example the valve rod 11 is tubular and open at both ends, whereupon the connecting duct 18 is formed by the internal space that extends axially through the valve rod between the ends of the valve rod. The valve rod 11 is advantageously made of a metal material with high heat-conducting capacity.

In the illustrated example the activating element 14 comprises a wax body 20. The valve rod 11 extends through said wax body 20 to enable a transfer of heat to the wax body 20 from cooling fluid that flows through the connecting duct 18 inside the valve rod 11. A piston chamber 21 is arranged in the thermostat housing 2 and a piston 22 is displaceably received in said piston chamber. The valve rod 11 extends through the piston chamber 21, and the piston 22 is fixedly connected with and disposed on the exterior of the valve rod 11. The wax body 20 is housed in the piston chamber 21 and arranged so as to act upon a piston 22. When the cooling fluid that flows through the connecting duct 18 has a temperature that is below the melting temperature of the wax substance in the wax body 20, the wax body is in a solid state and the valve body 10 is then located in the first end position illustrated in FIG. 3. When the wax body 20 is, under the action of heat from cooling fluid that flows through the connecting duct 18, heated to said melting temperature, the wax body will begin to melt. As the wax body 20 melts it increases in volume and thus exerts compressive force on the piston 22, so that said piston is displaced together with the valve rod 11 and the valve body 10 against the action of the spring device 15. The valve body 10 is thus displaced from the aforesaid first end position in the direction of the aforesaid second end position. When essentially the entire wax body 20 has melted, the valve body 10 reaches the second end position. When the wax body 20 then, due to the reduced temperature of the cooling fluid that flows through the connecting duct 18, has cooled to a temperature below said melting temperature, the wax body begins to stiffen. As the wax body 20 stiffens it decreases in volume, whereupon the piston 22 together with the valve rod 11 and the valve body 10 is displaced in the opposite direction under the action of the spring device 15.

In the illustrated example, sealing members 23a, 23b in the form of O-rings are arranged between the valve rod 11 and the thermostat housing 2 on either side of the piston chamber 21.

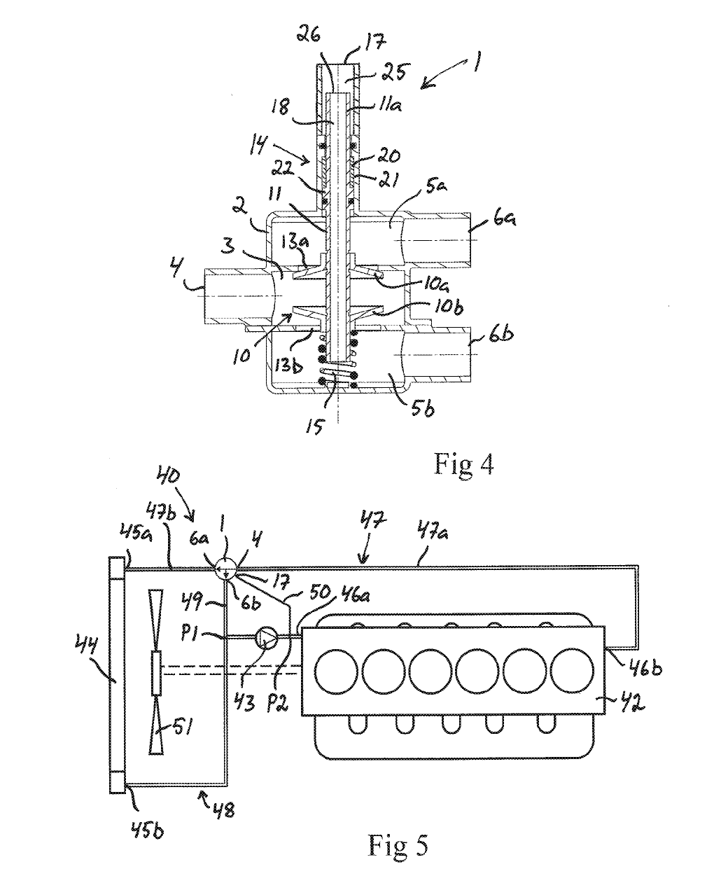

In the embodiment illustrated in FIGS. 1-3, the inlet opening 17 in the thermostat device 1 that is intended for connection to the pilot line is arranged in one end 11 a of the valve rod that projects from the thermostat housing 2 through an opening 24 therein. The pilot line is in this case intended to be connected directly to said projecting end 11a of the valve rod, and the relevant inlet opening 17 in this case also constitutes an inlet opening in the connecting duct 18. FIG. 4 illustrates an alternative embodiment in which the inlet opening 17 in the thermostat device 1 that is intended for connection to the pilot line is instead arranged in the thermostat housing 2, whereupon the valve rod 11 extends, with its one end 11a, into the inlet duct 25 that is arranged in the thermostat housing 2 and connected to said inlet opening 17. The pilot line in the latter case is intended to be connected to the thermostat housing 2, and the connecting duct is in this case provided with an inlet opening 26 that is intended to be free-standing from the pilot line. With the exception of these differences in detail, the thermostat device illustrated in FIG. 4 is consistent with the thermostat device illustrated in FIGS. 1-3 and the thermostat device described above.

FIG. 5 schematically illustrates a cooling system 40 according to the present invention, which cooling system is intended for a motor vehicle. This cooling system 40 comprises a cooling circuit 41 for cooling a combustion engine 42 in the vehicle by means of a cooling fluid flowing in the cooling circuit, preferably in the form of water with optional freezing point-lowering additives such as, for example, glycol. A cooling fluid pump 43 is coupled into the cooling circuit 41 to circulate the cooling fluid in the cooling circuit. A radiator 44, e.g. in the form of a conventional cooling fluid radiator, is also coupled into the cooling circuit 41 to cool said cooling fluid. Said radiator 44 comprises a cooling fluid inlet 45a that is connected with a cooling fluid outlet 46b in the combustion engine 42 via a first line 47 of the cooling circuit and a cooling fluid outlet 45b that is connected with a cooling fluid inlet 46a in the combustion engine 42 via a second line 48 of the cooling circuit. Said first line 47 is connected with said second line 48 via a third line 49 of the cooling circuit. Said third line 49 is connected to the second line 48 at a first point P1 and arranged so as to allow cooling fluid to be returned from the cooling fluid outlet 46b of the combustion engine to a cooling fluid inlet 46a of the combustion engine without cooling fluid passing through said radiator 44. The third line 49 thus constitutes a bypass line, via which the cooling fluid circulating in the cooling circuit 41 can bypass the radiator 44 in its passage between the cooling fluid outlet 46b and the cooling fluid inlet 46a of the combustion engine 42. The cooling fluid between the cooling fluid inlet 46a and the cooling fluid outlet 46b of the combustion engine is circulated through cooling fluid ducts inside the combustion engine while absorbing heat from the combustion engine.

The cooling fluid that flows through the radiator 44 is cooled by means of air that is blown against the radiator when the motor vehicle is in motion. The cooling system 40 can also comprise a fan 51 that is arranged so as to generate an airflow through the radiator 44. This fan 51 can be coupled to the combustion engine 42 in order to be driven thereby.

A thermostat device 1 of the type described above is coupled into the cooling circuit 41 in such a way that:
the inlet duct 3 of the thermostat device is connected with the cooling fluid outlet 46b of the combustion engine 42 via a first line section 47a of the first line 47,
the first outlet duct 5a of the thermostat device is connected with the cooling fluid inlet 45a of the radiator 44 via a second line section 47b of the first line 47,
the second outlet duct 5b of the thermostat device is connected with the third line 49, and
the inlet opening 17 of the thermostat device is connected with a pilot line 50 of the cooling circuit 40.

The pilot line 50 is connected to the second line 48 at a second point P2 located between said first point P1 and the cooling fluid inlet 46a of the combustion engine 42. A small part of the cooling fluid that is fed to the cooling fluid inlet 46a of the combustion engine is diverted to the pilot line 50 from the second line 48 and conducted by the pilot line to the thermostat device 1. In the thermostat device 1, the cooling fluid received from the pilot line 50 is brought into heat-transferring contact with the activating element 14 and then conducted back to the second line 48 via the connecting duct 18 and the second outlet duct 5b in the thermostat device 1 and the third line 49. The cooling fluid that is conducted to the thermostat device 1 via the pilot line 50 has the same temperature as the cooling fluid that is conducted into the combustion engine 42. The activating element 14 of the thermostat device thus comes to be controlled by the temperature of the cooling fluid that is conducted into the combustion engine 42.

When the temperature of the cooling fluid in the cooling circuit 41 is low, the wax body 20 remains in a solid state and the valve body 10 is kept in the aforesaid first end position, whereupon all the cooling fluid that flows from the combustion engine 42 via the first line 37 to the thermostat device 1 is returned to the combustion engine 42 via the third line 49 and the second line 48 without passing through the radiator 44. When the cooling fluid in the cooling circuit 41 has become hot enough that the wax body 20 has begun to melt, the valve body 10 will assume a position between the aforesaid first and second end positions, whereupon a certain amount of the cooling fluid that flows via the first line 47 from the combustion engine 42 to the thermostat device 1 is conducted further to the radiator 44 and cooled therein before the cooling fluid is returned via the second line 48 to the combustion engine, while a second amount of cooling fluid is returned to the combustion engine 42 via the third line 49 and the second line 48 without passing through the radiator 44. When essentially the entire wax body 20 has melted, the valve body 10 assumes the aforesaid second end position, whereupon all the cooling fluid that flows via the first line 47 from the combustion engine 42 to the thermostat device 1 is conducted further to the radiator 44 and cooled therein before the cooling fluid is returned via the second line 48 to the combustion engine 42.

The thermostat device according to the invention and the cooling system according to the invention are intended in particular to be used in a heavy motor vehicle such as a bus, a tractor or a goods vehicle.

The invention is obviously in no way limited to the embodiments described above, but rather a number of possible modifications thereof should be obvious to one skilled in the art without deviating from the basic idea of the invention as it is defined in the accompanying claims.

1.-10. (canceled)

11. A thermostat device for a cooling system in a motor vehicle, which thermostat device comprises:
an inlet duct for receiving cooling fluid that has been circulated through a combustion engine in the motor vehicle;
an inlet opening for receiving cooling fluid from a pilot line of the cooling system;
a first outlet duct, which is connected with the inlet duct and for conducting cooling fluid to a radiator in the cooling system;
a second outlet duct, which is connected with the inlet duct and for returning cooling fluid to the combustion engine without the fluid passing through the radiator;
a valve body, which is displaceable between various positions for regulating the flow of cooling fluid from the inlet duct to one or both of the outlet ducts;
an axially displaceable valve rod on which the valve body is secured, a temperature-dependent activating element configured and arranged to cause displacement of axial positions of the valve rod and the valve body dependent upon temperature of the cooling fluid that is received by the inlet opening wherein;
a connecting duct that extends in an axial direction through the valve rod for connecting the inlet opening with the second outlet duct;
the activating element is configured to displace the valve rod and the valve body in one axial direction when heated and in an opposite axial direction when cooled; and
the valve rod is configured in order to allow a transfer of heat to the activating element from cooling fluid that flows through the connecting duct inside the valve rod.

12. A thermostat device according to claim 11, further comprising:
the temperature dependent activating element is configured to expand in volume when heated and reduce in volume when cooled; and
the valve rod extends in such proximity to the activating element and the valve rod is configured in order to allow a transfer of heat to the activating element from cooling fluid that flows through the connecting duct inside the valve rod.

13. A thermostat device according to claim 11, further comprising:
a piston chamber, a piston displaceable in the piston chamber;
the valve rod also extends through the piston chamber;
the piston is fixedly connected with the valve rod; and
the activating element is housed in the piston chamber and is configured and arranged to act on the piston as the volume of the activating element changes.

14. A thermostat device according to claim 11, further comprising:
a first valve seat arranged between the inlet duct and the first outlet duct, and a second valve seat arranged between the inlet duct and the second outlet duct;
the valve body comprises a first valve member which, in a first end position displacement of the valve body, is receivable in the first valve seat to prevent cooling fluid flowing from the inlet duct to the first outlet duct; and
the valve body comprises a second valve member which, in a second end position displacement of the valve body, is receivable in the second valve seat to prevent cooling fluid from flowing from the inlet duct to the second outlet duct.

15. A thermostat device according to claim 14, further comprising a spring device configured for acting on the valve body or on the valve rod, the valve body being displaceable from the first end position in the direction of the second end position under the action of the activating element and against a spring force of the spring device.

16. A thermostat device according to claim 11, wherein the valve rod is tubular and is open at both ends thereof, whereby the connecting duct comprises an internal space in the valve rod between the ends of the valve rod.

17. A thermostat device according to claim 16, wherein the inlet opening is arranged in one end of the valve rod.

18. A cooling system for a motor vehicle, comprising:
a cooling circuit for cooling a combustion engine in the vehicle by means of cooling fluid flowing in the cooling circuit;
a cooling fluid pump for circulating the cooling fluid in the cooling circuit;
a radiator coupled into the cooling circuit for cooling the cooling fluid, the radiator comprises a cooling fluid inlet that is connected with a cooling fluid outlet of the combustion engine via a first line in the cooling circuit, and a cooling fluid outlet that is connected with a cooling fluid inlet of the combustion engine via a second line in the cooling circuit, a third line in the cooling circuit connecting the first line with the second line;
the third line is connected to the second line at a first point, and the third line is arranged to allow the cooling fluid to return to the combustion engine without passing through the radiator;
a thermostat device according to claim 11 coupled into the first line, wherein:
the inlet duct of the thermostat device is connected with the cooling fluid outlet of the combustion engine;
the first outlet duct of the thermostat device is connected with the cooling fluid inlet of the radiator;
the second outlet duct of the thermostat device is connected with said third line; and
a pilot line in the cooling circuit, the inlet opening of the thermostat device is connected with the pilot line in the cooling circuit, and the pilot line is connected to the second line at a second point located between the first point and the cooling fluid inlet of the combustion engine.

19. A thermostat device according to claim 11, further comprising:
the activating element comprises a wax body which expands in volume when heated and reduces in volume when cooled; and
the valve rod extends through the wax body and the valve rod is configured in order to allow a transfer of heat to the wax body from cooling fluid that flows through the connecting duct inside the valve rod.

20. A thermostat device according to claim 19, further comprising:
a piston chamber, a piston displaceable in the piston chamber the valve rod also extends through the piston chamber;
the piston is fixedly connected with the valve rod; and
the activating element is housed in the piston chamber and is configured and arranged to act on the piston as the volume of the activating element changes.
